(19) United States
(12) Patent Application Publication
(10) Pub. No.: US 2016/0240885 A1
(43) Pub. Date: Aug. 18, 2016

(54) LITHIUM ION SECONDARY BATTERY

(71) Applicant: HITACHI CHEMICAL COMPANY, LTD., Tokyo (JP)

(72) Inventor: Takuya NISHIMURA, Fukaya-shi, Saitama (JP)

(21) Appl. No.: 15/025,446

(22) PCT Filed: Sep. 26, 2014
(86) PCT No.: PCT/JP2014/075731

§ 371 Date: Mar. 28, 2016

(30) Foreign Application Priority Data
Sep. 30, 2013 (JP) 2013-205268

(51) Int. Cl. H01M 10/0525; H01M 4/13; H01M 10/0569; H01M 2/16

(52) U.S. Cl. CPC H01M 10/0525; H01M 2/1613; H01M 2/1626; H01M 2/162; H01M 4/13; H01M 10/0569; H01M 2004/021

(57) ABSTRACT

Provided is a lithium ion secondary battery, wherein a separator has a porosity of from 80% to 98% and at least one of the following conditions (1) and (2) is fulfilled: (1) a cathode includes a first current collector and a cathode mixture applied onto at least one side of the first current collector, wherein an amount of the cathode mixture applied onto the one side of the first current collector is from 1 mg/cm² to 10 mg/cm² and a volume porosity of the cathode mixture is from 20% by volume to 45% by volume; and (2) an anode includes a second current collector and an anode mixture applied onto at least one side of the second current collector, wherein an amount of the anode mixture applied onto the one side of the second current collector is from 1 mg/cm² to 10 mg/cm² and a volume porosity of the cathode mixture is from 20% by volume to 45% by volume.

### TECHNICAL FIELD

The present invention relates to a lithium ion secondary battery.

### BACKGROUND ART

Nonaqueous electrolyte secondary batteries such as lithium ion batteries are advantageous in terms of having high energy density, low self-discharge, and favorable cycling performance. Therefore, in recent years, the use of nonaqueous electrolyte secondary batteries as power sources for various industrial machines and industrial instruments by increasing their size or capacity has been anticipated.

Carbonate solvents that easily dissolve lithium salts and that tend not to be affected by electrolysis, such as ethylene carbonate or diethyl carbonate, have been used as the nonaqueous solvents used in the nonaqueous electrolyte of such lithium ion secondary batteries.

Recently, the use of an ionic liquid has been widely investigated as a nonaqueous electrolyte for lithium ion secondary batteries from the viewpoint of safety (see, for example, Japanese Patent Application Laid-Open (JP-A) No. 2010-287380).

### SUMMARY OF INVENTION

### Technical Problem

An ionic liquid is an ionic material that is in a liquid state even at normal temperatures (about 30° C.) and that not only has the characteristic of exhibiting high ion conductivity but also has characteristics that are excellent for the safety of lithium ion secondary batteries, such as low vapor pressure, nonvolatility, and flame retardancy. The nonaqueous electrolyte of a lithium ion secondary battery is required to be electrochemically stable and an ionic liquid has a stable potential window that is equivalent or superior to those of carbonate-based solvents.

However, since an ionic liquid is high in viscosity and low in electrical conductivity as compared with carbonate solvents, it has the problems of having inferior large-current charge and discharge properties.

In order to solve these problems, excellent large-current charge and discharge properties are attained using a specific separator in JP-A No. 2010-287380.

However, as a result of intensive research by the inventors of the present invention, the inventors found that large-current loading characteristics could not be attained only by using the kind of specific separator disclosed in JP-A No. 2010-287380.

In light of these circumstances, the present invention solves the problems in the conventional techniques, and the object thereof is to provide a lithium ion secondary battery having excellent large-current characteristics even when an ionic liquid is used as an electrolyte.

### Solution to Problem

Specific means for accomplishing the above-described objects are as follows.

<1> A lithium ion secondary battery, comprising:

a cathode;

an anode;

a separator; and

an electrolyte comprising an ionic liquid and a lithium salt,

wherein the separator has a porosity of from 80% to 98%, and

at least one of the following conditions (1) or (2) is fulfilled:

(1) the cathode comprises a first current collector and a cathode mixture applied onto at least one side of the first current collector, wherein an amount of the cathode mixture applied onto the one side of the first current collector is from 1 mg/cm² to 10 mg/cm² and a volume porosity of the cathode mixture is from 20% by volume to 45% by volume; and

(2) the anode comprises a second current collector and an anode mixture applied onto at least one side of the second current collector, wherein an amount of the anode mixture applied onto the one side of the second current collector is from 1 mg/cm² to 10 mg/cm² and a volume porosity of the cathode mixture is from 20% by volume to 45% by volume.

<2> The lithium ion secondary battery according to <1>, wherein the separator is a nonwoven fabric comprising at least one selected from the group consisting of polyolefin fiber, glass fiber, cellulose fiber, and polyimide fiber.

<3> The lithium ion secondary battery according to <1> or <2>, wherein an anion component of the ionic liquid comprises at least one selected from the group consisting of N(C₄F₉SO₂)₂⁻, CF₃SO₃⁻, N(SO₂F)₂⁻, N(SO₂CF₃)₂⁻, and N(SO₂CF₂CF₃)₂⁻.

<4> The lithium ion secondary battery according to any one of <1> to <3>, wherein a cation component of the ionic liquid comprises at least one selected from the group consisting of a chain quaternary ammonium cation, a piperidinium cation, a pyrrolidinium cation, and an imidazolium cation.

<5> The lithium ion secondary battery according to any one of <1> to <4>, wherein the cathode mixture or the anode mixture comprises an active material having a median diameter determined by a laser diffraction method of from 0.3 μm to 30 μm.

### Advantageous Effects of Invention

According to the present invention, a lithium ion secondary battery can be provided which has excellent large-current characteristics even when an ionic liquid is used as an electrolyte.

### DESCRIPTION OF EMBODIMENTS

Hereinbelow, the lithium ion secondary battery of the present invention will be described in detail.

In this specification, a numerical range expressed using “to” represents a range including the value written before and after the “to” as the minimum and the maximum thereof, respectively. When a composition contains a plurality of substances that correspond to the same component of the composition, the amount of the component in the composition means the total amount of the plurality of substances present in the composition, unless otherwise stated. A cathode is defined to be the side on which lithium ions are emitted (released) during charge and lithium ions are absorbed (intercalated) during discharge. An anode is defined to be the side on which lithium ions are absorbed (intercalated) during charging and lithium ions are emitted (released) during discharging.

A lithium ion secondary battery of the present invention includes a cathode, an anode, a separator, and an electrolyte including an ionic liquid and a lithium salt.

As a result of earnest investigations, the inventors of the present invention have found that a lithium ion secondary battery having excellent large-current characteristics even when an ionic liquid is used as an electrolyte can be provided by adjusting the porosity of a separator to from 80% to 98% and fulfilling at least one condition of the following (1) or (2), thereby completing the present invention: (1) a cathode includes a first current collector and a cathode mixture applied onto at least one side of the first current collector, wherein the amount of the cathode mixture applied onto the one side of the first current collector is from 1 mg/cm² to 10 mg/cm² and the volume porosity of the cathode mixture is from 20% by volume to 45% by volume; and (2) an anode includes a second current collector and an anode mixture applied onto at least one side of the second current collector, wherein the amount of the anode mixture applied onto the one side of the second current collector is from 1 mg/cm² to 10 mg/cm² and the volume porosity of the cathode mixture is from 20% by volume to 45% by volume.

Hereinbelow, each of the elements that constitute the lithium ion secondary battery of the present invention is described.

—Cathode—

The cathode that fulfills condition (1) is described.

The cathode includes: a first current collector; and a cathode mixture applied onto at least one side of the first current collector. Specifically, for example, a cathode plate formed by coating a cathode mixture onto at least one side of a first current collector, followed by drying and pressing is used as the cathode.

Metals such as aluminum, titanium, or tantalum, and alloys thereof are used as the material of a first current collector (referred to also as “cathode current collector”). Of these, the material of a first current collector is preferably aluminum, which is lightweight, or an alloy thereof, from the viewpoint of weight energy density.

The cathode mixture includes a cathode active material. The cathode mixture may further comprise an electroconductive agent, a binder, or the like.

A lithium transition metal compound or the like is used as a cathode active material.

Examples of the lithium transition metal compound include lithium transition metal oxides and lithium transition metal phosphates.

As a lithium transition metal oxide, a lithium transition metal oxide represented by the chemical formula LiMO₂ (M is at least one transition metal) is used.

As a lithium transition metal oxide, there may also be used lithium transition metal oxides formed by replacing part of the transition metals, such as Mn, Ni, Co, or the like, of lithium transition metal oxides, such as lithium manganese oxides, lithium nickel oxides, lithium cobalt oxides, or the like, with different one or two or more transition metals.

As a lithium transition metal oxide, there may also be used those formed by replacing part of the transition metals of lithium transition metal oxides with metal element (representative element) such as Mg, Al, or the like. In the present invention, those formed by replacing part of the transition metals of lithium transition metal oxides with metal element (representative element) are also included in the lithium transition metal oxide.

Specific examples of the lithium transition metal oxide include Li(Co_{1/3}Ni_{1/3}Mn_{1/3})O₂, LiNi_{1/2}Mn_{1/2}O₂, and LiNi_{1/2}Mn_{3/2}O₄.

Examples of the lithium transition metal phosphate include LiFePO₄, LiMnPO₄, and LiMn_{X}M_{1-X}PO₄ (0.3≦x≦1, and M is at least one element selected from the group consisting of Fe, Ni, Co, Ti, Cu, Zn, Mg, and Zr).

The cathode active material has a median diameter measured by a laser diffraction method preferably within a range of from 0.3 μm to 30 μm, more preferably within a range of from 0.5 μm to 25 μm, and even more preferably within a range of from 0.5 μm to 10 μm. When a cathode active material having a median diameter within a range of from 0.3 μm to 30 μm is used, a specific surface area for reaction tends to be increased and an internal resistance tends to be decreased, whereby deterioration of large-current characteristics can be further suppressed.

The median diameter of a cathode active material as referred to herein means a value determined by the following method.

A cathode active material is added to pure water so that a concentration of 1% by mass may be attained, and is ultrasonically dispersed for 15 minutes, and then a particle diameter at which the cumulative distribution of volume basis is 50% is measured by a laser diffraction method. This particle diameter is defined as the median diameter of a cathode active material.

As an electroconductive agent for a cathode mixture, an electroconductive agent known in the art is used. Specifically, carbon materials such as graphite, acetylene black, carbon black, or carbon fiber are used as the electroconductive agent for a cathode mixture, but the electroconductive agent is not limited to these materials.

As a binder for a cathode mixture, a binder known in the art is used. Specifically, examples of the binder to be used include polyvinylidene fluoride, styrene-butadiene rubber, isoprene rubber, and acrylic rubber, but the binder is not limited to these materials. In the present invention, polyvinylidene fluoride is preferred as the binder for a cathode.

The cathode mixture may preferably be dispersed in a dispersion medium to form a slurry when it is applied onto one side of the first current collector. Dispersion media known in the art may be chosen appropriately and used as the dispersion medium. In the present invention, organic solvents such as N-methyl-2-pyrrolidone are preferred as the dispersion medium.

The mixing ratio of a cathode active material, and electroconductive agent, and a binder in a cathode mixture may be adjusted to 1:0.05 to 0.20:0.02 to 0.10 (cathode active material:conductive agent:binder) in mass ratio, provided that the amount of the cathode active material is taken as 1. The mass ratio, however, is not limited to this range.

The amount of a cathode mixture to be applied (the amount of a cathode mixture to be applied onto one side of a first current collector; also referred to as “coating amount”) is from 1 mg/cm² to 10 mg/cm², preferably from 1 mg/cm² to 7.5 mg/cm², and more preferably from 1 mg/cm² to 5.5 mg/cm². When the amount of a cathode mixture to be applied is 1 mg/cm² or more, it is advantageous because it becomes easy to make the cathode mixture uniform in thickness at the time of pressing and the energy density is allowed to be increased. When the amount of a cathode mixture to be applied is 10 mg/cm² or less, it is advantageous because the distance between a cathode and an anode (ion conduction diffusion distance) becomes short.

The amount of a cathode mixture to be applied may be determined by subtracting the mass of a first current collector from the mass of a cathode cut into a prescribed area.

The volume porosity of a cathode mixture is from 20% by volume to 45% by volume, preferably from 30% by volume to 45% by volume, and more preferably from 35% by volume to 45% by volume. When the volume porosity of a cathode mixture is 20% by volume or more, it is advantageous because the impregnating ability of an ionic liquid is improved. When the volume porosity of a cathode mixture is 45% by volume or less, it is advantageous because the adhesion between the cathode current collector and the mixture is improved. In addition, when the volume porosity of a cathode mixture is 45% by volume or less, it is advantageous because an electron network of the electroconductive agent is formed and the electronic resistance can be reduced.

The volume porosity of a cathode mixture is calculated from the compounding ratio of the materials used for the cathode mixture, the true specific gravity of respective materials, the thickness of the cathode mixture, the area of the cathode mixture, the density of the cathode mixture, and the like. Specifically, the volume porosity of a cathode mixture may be calculated, for example, from the following formula when the cathode mixture contains a cathode active material, an electroconductive agent, and a binder.

Volume porosity of cathode mixture (% by volume)=[1−{(i)+(ii)+(iii)/(width×length×thickness of cathode mixture)}]×100 Formula

Herein, (i) represents the volume occupied by the cathode active material in the cathode mixture, (ii) represents the volume occupied by the electroconductive agent in the cathode mixture, and (iii) represents the volume occupied by the binder in the cathode mixture. Each of (i), (ii) and (iii) can be calculated from the following formulae.

(i)=(the whole mass of the cathode mixture×the mass ratio occupied by the cathode active material in the cathode mixture)/the true specific gravity of the cathode active material Formula

(ii)=(the whole mass of the cathode mixture×the mass ratio occupied by the electroconductive agent in the cathode mixture)/the true specific gravity of the electroconductive agent Formula

(iii)=(the whole mass of the cathode mixture×the mass ratio occupied by the binder in the cathode mixture)/the true specific gravity of the binder Formula

True specific gravity can be measured according to the test methods for density and relative density of chemical products described in JIS K0061 (2001).

The thickness (also referred to as “coated thickness”) of a cathode mixture is preferably from 20 μm to 80 μm, and more preferably from 20 μm to 50 μm. When the thickness of a cathode mixture is 20 μm or more, it is advantageous because it becomes easy to make the cathode mixture uniform in thickness at the time of pressing and Li⁺ concentration distribution in the cathode following charging and discharging becomes less prone to occur. When the thickness of a cathode mixture is 80 μm or less, it is advantageous because deterioration of the electrical conductivity of the ionic liquid in pores in the cathode mixture can be inhibited.

When the anode fulfills condition (2), the cathode does not need to fulfill condition (1), and may have, for example, any well-known configuration using a metal lithium as a cathode active material. However, from the viewpoint of improving large-current characteristics in a lithium ion secondary battery using an ionic liquid as an electrolyte, it is preferable that the cathode fulfills condition (1) even when the anode fulfills condition (2).

—Anode—

The anode that fulfills condition (2) is described.

The anode includes: a second current collector; and an anode mixture applied onto at least one side of the second current collector. Specifically, for example, an anode plate formed by coating an anode mixture onto at least one side of a second current collector, followed by drying and pressing is used as the anode.

Metals such as aluminum, copper, nickel, or stainless steel, alloys thereof, and the like are used as the material of a second current collector (referred to also as “anode current collector”). Of these, the material of a second current collector is preferably aluminum, which is lightweight, or an alloy thereof, from the viewpoint of weight energy density. The material of a second current is preferably copper from the viewpoints of easiness in production of a thin film and cost.

The anode mixture includes an anode active material. The anode mixture may further comprise an electroconductive agent, a binder, or the like.

Examples of the anode active material include (1) lithium titanate (Li₄Ti₅O₁₂), (2) carbon materials such as graphite or amorphous carbon, (3) metal materials including tin, silicon, or the like, and (4) metal lithium.

From the viewpoints of safety, cycling characteristics, and low temperature characteristics, it is preferred to use lithium titanate as the anode active material.

The anode active material has a median diameter measured by a laser diffraction method preferably within a range of from 0.1 μm to 50 μm, more preferably within a range of from 0.3 μm to 30 μm, and even more preferably within a range of from 0.3 μm to 20 μm. When an anode active material having a median diameter within a range of from 0.1 μm to 50 μm (particularly, a range of from 0.3 μm to 30 μm) is used, a specific surface area for reaction tends to be increased and an internal resistance tends to be decreased, whereby deterioration of large-current characteristics can be further suppressed.

Herein, the median diameter of an anode active material is a median diameter measured by the same method as the method for the cathode active material.

An electroconductive agent known in the art may be used as the electroconductive agent for an anode mixture. Specific examples and preferable materials thereof are the same as those of the electroconductive agent to be used for the cathode mixture.

A binder known in the art may be used as the binder for an anode mixture. Specific examples and preferable materials thereof are the same as those of the binder to be used for the cathode mixture.

The anode mixture may preferably be dispersed in a dispersion medium to form a slurry when it is applied onto one side of the second current collector. Specific examples and preferable materials of the dispersion medium are the same as those of the dispersion medium to be used for the cathode mixture.

The mixing ratio of an anode active material, an electroconductive agent, and a binder in an anode mixture may be adjusted to 1:0.01 to 0.20:0.02 to 0.10 (anode active material:conductive agent:binder) in mass ratio, provided that the amount of the anode active material is taken as 1. The mass ratio, however, is not limited to this range.

The amount of an anode mixture to be applied (the amount of an anode mixture to be applied onto one side of a second current collector; also referred to as “coating amount”) is from 1 mg/cm² to 10 mg/cm², preferably from 1 mg/cm² to 8 mg/cm², and more preferably from 1 mg/cm² to 7 mg/cm². When the amount of an anode mixture to be applied is 1 mg/cm² or more, it is advantageous because it becomes easy to make the cathode mixture uniform in thickness at the time of pressing and the energy density is allowed to be increased. When the amount of an anode mixture to be applied is 10 mg/cm² or less, it is advantageous because the distance between a cathode and an anode (ion conduction diffusion distance) becomes short.

The amount of an anode mixture to be applied may be determined by subtracting the mass of a second current collector from the mass of an anode cut into a prescribed area.

The volume porosity of an anode mixture is from 20% by volume to 45% by volume, preferably from 30% by volume to 45% by volume, and more preferably from 35% by volume to 45% by volume. This is for the same reason as the cathode mixture.

The volume porosity of the anode mixture is calculated from the compounding ratio of the materials used for the anode mixture, the true specific gravity of each materials, the thickness of the anode mixture, the area of the anode mixture, the density of the anode mixture, and the like. Specifically, the volume porosity of an anode mixture may be calculated, for example, from the following formula when the anode mixture contains an anode active material, an electroconductive agent, and a binder.

Volume porosity of anode mixture (% by volume)=[1−{(i)+(ii)+(iii)/(width×length×thickness of anode mixture)}]×100 Formula

Herein, (i) represents the volume occupied by the active material in the anode mixture, (ii) represents the volume occupied by the electroconductive agent in the anode mixture, and (iii) represents the volume occupied by the binder in the anode mixture. Each of (i), (ii) and (iii) can be calculated from the following formulae.

(i)=(the whole mass of the anode mixture×the mass ratio occupied by the anode active material in the anode mixture)/the true specific gravity of the anode active material Formula

(ii)=(the whole mass of the anode mixture×the mass ratio occupied by the electroconductive agent in the anode mixture)/the true specific gravity of the conductive agent Formula

(iii)=(the whole mass of the anode mixture×the mass ratio occupied by the binder in the anode mixture)/the true specific gravity of the binder Formula

True specific gravity can be measured according to test methods for density and relative density of chemical products described in JIS K0061 (2001).

The thickness (also referred to as “coated thickness”) of an anode mixture is preferably from 20 μm to 80 μm, and more preferably from 20 μm to 50 μm. This is for the same reason as the cathode.

When the cathode fulfills condition (1), the anode does not need to fulfill condition (2), and may have, for example, any well-known configuration using metal lithium as an anode active material. However, from the viewpoint of improving large-current characteristics in a lithium ion secondary battery using an ionic liquid as an electrolyte, it is preferable that the anode fulfills condition (2) even when the cathode fulfills condition (1).

—Separator—

The material and shape of the separator are not particularly limited. As the material of a separator, however, it is preferred to use a material that is stable against the electrolyte and has excellent liquid holding property. Specific examples thereof which are preferably used include: a porous membrane of a polyolefin, including polyethylene, polypropylene, or the like; and nonwoven fabric including polyolefin fiber (such as polyethylene fiber, or polypropylene fiber), glass fiber, cellulose fiber, polyimide fiber, or the like. Of these, from the viewpoints of stability with the electrolyte and excellent liquid holding property, nonwoven fabric is preferred as the separator, and nonwoven fabric including at least one selected from the group consisting of polyolefin fiber, glass fiber, cellulose fiber, and polyimide fiber is more preferred.

It is more preferable that the separator is a porous substrate containing a glass fiber and a resin.

<Glass Fiber>

The glass fiber may be alkali glass or alternatively may be alkali-free glass. The glass fiber is not particularly limited in fiber diameter, and the number average fiber diameter thereof is preferably from 0.5 μm to 5.0 μm, more preferably from 0.5 μm to 4.0 μm, and even more preferably from 0.5 μm to 2.0 μm. When the fiber diameter of the glass fiber is 0.5 μm or more, it tends to be easy to render pores uniform in diameter. On the other hand, when the fiber diameter of the glass fiber is 5.0 μm or less, it becomes easy to produce an electrochemical separator being sufficiently thin (for example, 50 μm or less) and favorable pulp moldability tends to be obtained easily at the time of the pulp molding described below.

In addition, the glass fiber is not particularly limited in fiber length, and the number average fiber length thereof is preferably from 1.0 μm to 30 mm, more preferably from 100 μm to 20 mm, and even more preferably from 500 μm to 10 mm. When the fiber length of the glass fiber is 1.0 μm or more, it tends to be easy to render pores uniform in diameter. On the other hand, when the fiber length of the glass fiber is 30 mm or less, it becomes easy to produce an electrochemical separator having sufficiently high strength (for example, 5 MPa or more) and favorable pulp moldability tends to be obtained easily at the time of the pulp molding described below.

The number average fiber diameter and the number average fiber length of a fiber may be determined, for example, by direct observation using a dynamic image analysis method, a laser scanning method (in accordance with JIS L1081, for example), a scanning electron microscope, or the like. Specifically, the fiber diameter and the fiber length may be determined by observing about fifty fibers using these methods, and calculating average values.

<Resin>

The resin is not particularly limited as long as it is a compound capable of working as a binder for inorganic materials. The resin is preferably a resin having a melting temperature of from 100° C. to 300° C., more preferably a resin having a melting temperature of from 100° C. to 180° C., and even more preferably a resin having a melting temperature of from 100° C. to 160° C. When the melting temperature of the resin is 100° C. or more, there is a tendency to obtain shutdown properties on short circuit easily. When the melting temperature of the resin is 300° C. or less, there is a tendency for a production step (drying) to be simplified. Herein, a melting temperature is a value measured on the basis of JIS K7121.

Examples of such a resin include organic fiber and a polymer particle.

Examples of organic fiber include natural fiber, regenerated fiber, and synthetic fiber. It is preferred to use, as organic fiber, at least one selected from the group consisting of aramid fiber, polyamide fiber, polyester fiber, polyurethane fiber, polyacrylic fiber, polyethylene fiber, and polypropylene fiber, for example. Such organic fibers may be used singly or may be used in combination of two or more thereof

It is preferred to use, as a polymer particle, at least one selected from the group consisting of a polyolefin particle, a polybutyl acrylate particle, a crosslinked polymethyl methacrylate particle, a polytetrafluoroethylene particle, a benzoguanamine particle, a crosslinked polyurethane particle, a crosslinked polystyrene particle, and a melamine particle. Such polymer particles may be used singly, or may be used in combination of two or more thereof.

<Inorganic Filler Different from Glass Fiber>

The porous substrate may include an inorganic filler different from the glass fiber (hereinafter referred simply as “inorganic filler”). An inorganic filler is capable of serving as a binding aid for the glass fiber and resin. Furthermore, the inorganic filler itself is capable of enhancing the heat resistance of a separator, is capable of trapping the impurities (such as hydrogen fluoride gas, or heavy metal ions) in a nonaqueous electrolyte, or is capable of minimizing the pore diameter.

Examples of the inorganic filler include: fillers made of electrically insulating materials such as a metal oxide, a metal nitride, a metal carbide, or a silicon oxide; and fillers made of carbon nanotube, carbon nanofiber, or the like. These fillers may be used singly, or may be used in combination of two or more thereof. Examples of the metal oxide include Al₂O₃, SiO₂ (excluding fibrous ones), sepiolite, attapulgite, wollastonite, montmorillonite, mica, ZnO, TiO₂, BaTiO₃, ZrO₂, zeolite, and imogolite. Of these, sepiolite filler may suitably be used. It is capable of trapping hydrogen fluoride generated in an electrolyte during battery operation by use of the sepiolite filler.

Sepiolite is a clay mineral on a hydrous magnesium silicate basis and is generally represented by the following chemical formula (x):

Mg₈Si₂O₃₀(OH₂)₄(OH)₄.6-8H₂O (x)

The shape of the inorganic filler is not particularly limited, and the inorganic filler may be any of a crushed filler (amorphous filler), a scale-like filler (tabular filler), a fibrous filler (needle-like filler), or a spherical filler, for example. A fibrous filler is preferred as the inorganic filler from the viewpoint of further improving separator strength.

In a case of using a fibrous filler, the number average fiber diameter of the fibrous filler is preferably from 0.01 μm to 1.0 μm, more preferably from 0.01 μm to 0.5 μm, and even more preferably from 0.01 μm to 0.1 μm. When the fiber diameter of the fibrous filler is 0.01 μm or more, it tends to be easy to render pores uniform in diameter. On the other hand, when the fiber diameter of the fibrous filler is 1.0 μm or less, there is a tendency to become easy to produce an electrochemical separator being sufficiently thin (for example, 50 μm or less). The number average fiber length of the fibrous filler is preferably from 0.1 μm to 500 μm, more preferably from 0.1 μm to 300 μm, and even more preferably from 0.1 μm to 100 μm. When the fiber length of the fibrous filler is 0.1 μm or more, it tends to be easy to render pores uniform in diameter. On the other hand, when the fiber length of the fibrous filler is 500 μm or less, there is a tendency to become easy to produce an electrochemical separator being sufficiently thin (for example, 50 μm or less).

<Pulp>

The porous substrate may further include a micronized pulp. The pulp to be optionally used may be any of a wood pulp, a non-wood pulp, a mechanical pulp, and a chemical pulp. In order to improve separator strength, the degree of freeness of pulp (CSF value) is preferably 300 (also expressed as “CSF-300 ml”) or less, and more preferably 150 or less. Preferably, the lower limit of the degree of freeness of pulp is 0.

<Physical Properties of Separator>

The air permeability (Gurley value) of a separator is preferably from 0.1 seconds/100 ml to 10 seconds/100 ml. When the air permeability is 0.1 seconds/100 ml or more, the ion conductivity tends to be easily improved. When the air permeability is 10 seconds/100 ml or less, defective short circuit can be further reduced. From such viewpoints, the air permeability of a separator is more preferably from 0.1 seconds/100 ml to 5 seconds/100 ml. The air permeability of the separator may be measured in accordance with JIS P8142 (2005).

The pore diameter of the separator is preferably from 0.01 μm to 20 μm. When the pore diameter is 0.01 μm or more, the ion conductivity can be easily improved. When the pore diameter is 20 μm or less, defective short circuit can be suppressed. From such viewpoints, the pore diameter of the separator is more preferably from 0.01 μm to 1 μm. The pore diameter of the separator may be measured by mercury intrusion porosimetry, a bubble point method (JIS K3832 (1990)), or the like.

The porosity of the separator is from 80% to 98%. When a separator having a porosity of from 80% to 98% is used, a lithium ion secondary battery using an ionic liquid as an electrolyte has excellent ion conductivity and the large-current characteristics thereof are improved. From such a viewpoint, the porosity of the separator is preferably from 85% to 98%, and more preferably from 90% to 98%.

From the viewpoint of rate capability, the total pore volume of the separator is preferably 2 ml/g or more. The upper limit of the total pore volume of the separator is not particularly limited, and is preferably 10 ml/g from a pragmatic viewpoint. From the viewpoint of rate capability, the total pore volume of the separator is more preferably from 3 ml/g to 10 ml/g, and even more preferably from 5 ml/g to 10 ml/g.

The porosity and the total pore volume of the separator are values obtained from mercury porosimeter measurement. The conditions for the mercury porosimeter measurement are as follows: Apparatus: AutoPore IV 9500 manufactured by Shimadzu Corporation; Mercury injection pressure: 0.51 psia; Pressure holding time at each measurement pressure: 10 s; Contact angle of the sample with mercury: 140°; Surface tension of mercury: 485 dynes/cm; Density of mercury: 13.5335 g/mL.

From the viewpoint of rate capability, the air permeability of a separator is preferably 10 s/100 ml or less. The lower limit of the air permeability of the separator is not particularly limited, and is preferably 0.1 s/100 ml from a pragmatic viewpoint. From the viewpoint of rate capability, the air permeability of the separator is more preferably from 0.1 s/100 ml to 10 s/100 ml, and even more preferably from 0.1 s/100 ml to 5 s/100 ml.

The air permeability of the separator is a value obtained from a Gurley tester method. The measurement conditions of the Gurley tester method are as follows, for example. Measurement is performed in accordance with the method specified in JIS P8117 (1998) by using a B type Gurley densometer (manufactured by Yasuda Seiki Seisakusho, Ltd.). A separator is clamped to a circular hole with a diameter of 28.6 mm and an area of 645 mm², and the inner cylinder (inner cylinder weight of 567 g) is operated to pass air from the cylinder to outside the cylinder through the test circular hole portion, and the duration required for passage of 100 mL of air is measured to determine the air permeability.

Since a separator is suitably used especially for lithium ion secondary batteries, the thickness thereof is preferably 50 μm or less, more preferably 30 μm or less, and even more preferably 20 μm or less. The lower limit of the thickness is preferably 10 μm or more from the viewpoint of fully securing heat resistance, strength, battery properties, or the like.

—Electrolyte—

The electrolyte is a nonaqueous electrolyte and contains an ionic liquid and a lithium salt. Specifically, it is preferred to use, as the electrolyte, a material prepared by dissolving a lithium salt in an ionic liquid which exhibits liquid properties at temperatures of −20° C. or more, for example.

The electrolyte may contain a compound having a carbonate structure. When a compound having a carbonate structure is contained, a coating film derived from the carbonate structure can be formed on an anode mixture by decreasing the charging voltage to the reductive decomposition potential of the compound having a carbonate structure during the first charge. Examples of the carbonate compound include ethylene carbonate, propylene carbonate, and vinylene carbonate. It is more preferred to use vinylene carbonate as the carbonate compound from the viewpoint of being able to form a coating film derived from a carbonate structure on an anode without increasing the charging voltage.

When a compound having a carbonate structure is contained, the content thereof is preferably from 0.1% by mass to 10% by mass, more preferably from 0.2% by mass to 5% by mass, and even more preferably from 0.5% by mass to 3% by mass.

A cation component of the ionic liquid is not particularly limited, and is preferably at least one selected from the group consisting of a chain quaternary ammonium cation, a piperidinium cation, a pyrrolidinium cation, and an imidazolium cation.

Examples of the chain quaternary ammonium cation include a chain quaternary ammonium cation represented by the following formula [1] (wherein X is a nitrogen atom or a phosphorus atom). Examples of the piperidinium cation include a piperidinium cation, which is a 6-membered ring cyclic compound containing nitrogen represented by the following formula [2]. Examples of the pyrrolidinium cation include a pyrrolidinium cation, which is a 5-membered ring cyclic compound represented by the following formula [3]. Examples of the imidazolium cation include an imidazolium cation represented by the following formula [4].

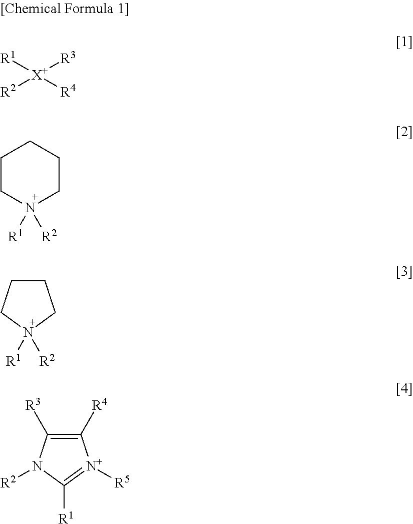

Herein, R¹, R², R³, and R⁴ of formulae [1] to [3] each independently represent an alkyl group having 1 to 20 carbon atoms or an alkoxyalkyl group represented by R⁶—O—(CH₂)—(wherein R⁶ represents a methyl group or an ethyl group, and n represents an integer of from 1 to 4). In a case of formula [1], the alkyl group is a chain alkyl group and the alkoxyalkyl group is a chain alkoxyalkyl group. In formula [4], R¹, R², R³, R⁴, and R⁵ are each independently an alkyl group having 1 to 20 carbon atoms, an alkoxyalkyl group represented by R⁶—O—(CH₂)ₙ—(wherein R⁶ represents a methyl group or an ethyl group, and n represents an integer of from 1 to 4), or a hydrogen atom.

An anion component of the ionic liquid is not particularly limited, and examples thereof include halogen anions such as Cl⁻, Br⁻, or I⁻, inorganic anions such as BF₄⁻ or N(SO₂F)₂⁻, and organic anions such as B(C₆H₅)₄⁻, CH₃SO₃⁻, CF₃SO₃⁻, N(C₄F₉SO₂)₂⁻, N(SO₂CF₃)₂⁻, or N(SO₂CF₂CF₃)₂⁻.

Of these, the anion component of the ionic liquid to be contained is preferably at least one selected from the group consisting of B(C₆H₅)₄⁻, CH₃SO₃⁻, N(C₄F₉SO₂)₂⁻, CF₃SO₃⁻, N(SO₂F)₂⁻, N(SO₂CF₃)₂⁻, and N(SO₂CF₂CF₃)₂⁻, more preferably at least one selected from the group consisting of N(C₄F₉SO₂)₂⁻, CF₃SO₃⁻, N(SO₂F)₂⁻, N(SO₂CF₃)₂⁻, and N(SO₂CF₂CF₃)₂⁻, and even more preferably N(SO₂F)₂⁻.

An ionic liquid containing at least one selected from the group consisting of N(C₄F₉SO₂)₂⁻, CF₃SO₃⁻, N(SO₂F)₂⁻, N(SO₂CF₃)₂⁻, and N(SO₂CF₂CF₃)₂⁻ as an anion component thereof, especially, an ionic liquid containing N(SO₂F)₂⁻, has a relatively low viscosity, and therefore its use leads to further improvement in charge and discharge properties.

In an ionic liquid, examples of preferred combinations of an anion component and a cation component thereof include a combination of N-methyl-N-propylpyrrolidinium and bis(fluorosulfonyl)imide (N(SO₂F)₂⁻), and a combination of N-methyl-N-propylpyrrolidinium and bis(trifluoromethylsulfonyl)imide (N(SO₂CF₃)₂⁻).

Ionic liquids may be used singly, or may be used in combination of two or more thereof.

Examples of the lithium salt include at least one selected from the group consisting of LiBF₄, LiClO₄, LiB(C₆H₅)₄, LiCH₃SO₃, LiCF₃SO₃, LiN(SO₂F)₂, LiN(SO₂CF₃)₂, and LiN(SO₂CF₂CF₃)₂. The lithium salt, however, is not limited to these materials.

The concentration of the lithium salt is preferably from 0.5 mol/L to 1.5 mol/L, more preferably from 0.7 mol/L to 1.3 mol/L, and even more preferably from 0.8 mol/L to 1.2 mol/L, with respect to the ionic liquid. Charge and discharge properties can be further improved by adjusting the concentration of the lithium salt to from 0.5 mol/L to 1.5 mol/L.

The method for producing a lithium ion secondary battery of the present invention including a cathode, an anode, a separator, and an electrolyte is not particularly limited, and methods known in the art may be used. The shape of the lithium ion secondary battery is not particularly limited, and a laminate type, a winding type, or the like is available.

### EXAMPLES

Hereinbelow, the present invention is described concretely with reference to examples and comparative examples, but the invention is not limited to these examples unless departing from the gist thereof.

### Example 1

A cathode mixture was prepared by adding 10% by mass of acetylene black (trade name: HS-100, Denka Company Limited) as an electroconductive agent and 5% by mass of polyvinylidene fluoride as a binder to 85% by mass of iron lithium phosphate (LiFePO₄) having a median diameter of 0.6 μm measured by a laser diffraction method as a cathode active material, followed by mixing them. The cathode mixture was dispersed in N-methyl-2-pyrrolidone as a dispersion medium to form a slurry, which was then applied onto a 20-μm thick aluminum foil so that the coated amount after drying of the dispersion medium would be 4.25 mg/cm², followed by drying at 120° C. for 1 hour. After the drying, pressing was performed, thereby producing a cathode in which the density of the cathode mixture was 1.7 g/ml, the coated thickness of the cathode mixture was 25 μm, and the volume porosity of the cathode mixture was 43% by volume. The density of the cathode mixture was calculated from the formula: the density of cathode mixture=(the mass of cathode−the mass of current collector [aluminum foil])/(the thickness of cathode mixture×the area of cathode mixture).

The cathode was cut into a rectangle having a size of 3.0 cm×3.5 cm and the cathode mixture was scraped from the aluminum foil with the cathode mixture in a size of 2.5 cm×2.5 cm remaining. An aluminum tub was connected by spot welding to the aluminum foil resulting from the scraping of the cathode mixture.

An anode mixture was prepared by adding 10% by mass of acetylene black (trade name: HS-100, Denka Company Limited) as an electroconductive agent and 5% by mass of polyvinylidene fluoride as a binder to 85% by mass of lithium titanate (Li₄Ti₅O₁₂) having a median diameter of 7.0 μm measured by a laser diffraction method as an anode active material, followed by mixing them. The anode mixture was dispersed in N-methyl-2-pyrrolidone as a dispersion medium to form a slurry, which was then applied onto a 20-μm thick aluminum foil so that the coated amount after drying of the dispersion medium would be 4.95 mg/cm², followed by drying at 120° C. for 1 hour. After the drying, pressing was performed, thereby producing an anode in which the density of the anode mixture was 1.6 g/ml, the coated thickness of the anode mixture was 33 μm, and the volume porosity of the anode mixture was 44% by volume. The density of the anode mixture was calculated from the formula: the density of anode mixture=(the mass of anode−the mass of current collector [aluminum foil])/(the thickness of anode mixture×the area of anode mixture).

The anode was cut into a rectangle having a size of 2.5 cm×3.0 cm and the anode mixture was scraped from the aluminum foil with the anode mixture in a size of 2.0 cm×2.0 cm remaining. An aluminum tub was connected by spot welding to the aluminum foil resulting from the scraping of the anode mixture.

Lithium bis(fluorosulfonyl)imide (hereinafter referred to as “LiFSI”) dried under a dry argon atmosphere was used as a solute (lithium salt), and an electrolyte was prepared by dissolving the solute in N-methyl-N-propylpyrrolidinium bis(fluorosulfonyl)imide (Py13FSI) as an ionic liquid in a proportion of 1 mol/L.

The cathode and the anode were inserted into an aluminum-laminated bag via a glass fiber nonwoven fabric A (GE Healthcare Japan; Model: GF/A) shown in Table 1 as a separator, and the bag was sealed by heat-welding with a part of its opening remaining. The electrolyte was poured through the unsealed opening and a vacuum was established in the aluminum-laminated bag, and then the unsealed opening was sealed by heat-welding, thereby forming a laminate cell.

### Example 2

A laminate cell was prepared in the same manner as in Example 1 except that a glass fiber nonwoven fabric B (Nippon Sheet Glass Co., Ltd.) shown in Table 1 was used as the separator.

### Example 3

A cathode mixture was prepared by adding 10% by mass of acetylene black (trade name: HS-100, Denka Company Limited) as an electroconductive agent and 5% by mass of polyvinylidene fluoride as a binder to 85% by mass of nickel lithium manganate (LiNi_{0.5}Mn_{1.5}O₄) having a median diameter of 9.6 μm measured by a laser diffraction method as a cathode active material, followed by mixing them. The cathode mixture was dispersed in N-methyl-2-pyrrolidone as a dispersion medium to form a slurry, which was then applied onto a 20-μm thick aluminum foil so that the coated amount after drying of the dispersion medium would be 5.10 mg/cm², followed by drying at 120° C. for 1 hour. After the drying, pressing was performed, thereby producing a cathode in which the density of the cathode mixture was 1.9 g/ml, the coated thickness of the cathode mixture was 27 μm, and the volume porosity of the cathode mixture was 43% by volume.

On the other hand, an anode mixture was prepared by adding 10% by mass of acetylene black (trade name: HS-100, Denka Company Limited) as an electroconductive agent and 5% by mass of polyvinylidene fluoride as a binder to 85% by mass of lithium titanate (Li₄Ti₅O₁₂) having a median diameter of 1.2 μm measured by a laser diffraction method as an anode active material, followed by mixing them. The anode mixture was dispersed in N-methyl-2-pyrrolidone as a dispersion medium to form a slurry, which was then applied onto a 20-μm thick aluminum foil so that the coated amount after drying of the dispersion medium would be 2.70 mg/cm², followed by drying at 120° C. for 1 hour. After the drying, pressing was performed, thereby producing an anode in which the density of the anode mixture was 1.8 g/ml, the coated thickness of the anode mixture was 17 μm, and the volume porosity of the anode mixture was 44% by volume.

Then, a laminate cell was prepared in the same manner as in Example 1 except that the glass fiber nonwoven fabric B (Nippon Sheet Glass Co., Ltd.) shown in Table 1 was used as the separator together with the cathode and the anode prepared as above.

### Example 4

A laminate cell was prepared in the same manner as in Example 3 except that a glass fiber nonwoven fabric C (Nippon Sheet Glass Co., Ltd.) shown in Table 1 was used as the separator.

### Comparative Example 1

A laminate cell was prepared in the same manner as in Example 1 except that the cellulose fiber nonwoven fabric shown in Table 1 was used as the separator.

### Comparative Example 2

A laminate cell was prepared in the same manner as in Example 1 except that the polyimide fiber nonwoven fabric shown in Table 1 was used as the separator.

### Comparative Example 3

A laminate cell was prepared in the same manner as in Example 3 except that the cellulose fiber nonwoven fabric shown in Table 1 was used as the separator.

### Example 5

A cathode mixture was prepared by adding 6% by mass of acetylene black (trade name: HS-100, Denka Company Limited) as an electroconductive agent and 5% by mass of polyvinylidene fluoride as a binder to 89% by mass of lithium manganese oxide (LiMn₂O₄) having a median diameter of 5.0 μm measured by a laser diffraction method as a cathode active material, followed by mixing them. The cathode mixture was dispersed in N-methyl-2-pyrrolidone as a dispersion medium to form a slurry, which was then applied onto a 20-μm thick aluminum foil so that the coated amount after drying of the dispersion medium would be 5.50 mg/cm², followed by drying at 120° C. for 1 hour. After the drying, pressing was performed, thereby producing a cathode in which the density of the cathode mixture was 2.2 g/ml, the coated thickness of the cathode mixture was 25 μm, and the volume porosity of the cathode mixture was 38% by volume.

The cathode was cut into a rectangle having a size of 2.5 cm×3.0 cm and the cathode mixture was scraped from the aluminum foil with the cathode mixture in a size of 2.0 cm×2.0 cm remaining. An aluminum tub was connected by spot welding to the aluminum foil resulting from the scraping of the cathode mixture.

As an anode, there was used a material prepared by connecting a nickel tub by spot welding to a copper mesh cut in a rectangle shape with a size of 3.0 cm×3.5 cm with a tub welding part remaining, and then adhering metal lithium onto the mesh.

Lithium bis(fluorosulfonyl)imide (hereinafter referred to as “LiFSI”) dried under a dry argon atmosphere was used as a solute (lithium salt), and an electrolyte was prepared by dissolving the solute in N-methyl-N-propylpyrrolidinium bis(fluorosulfonyl)imide (Py13FSI) as an ionic liquid in a proportion of 1 mol/L.

The cathode and the anode were inserted into an aluminum-laminated bag via a glass fiber nonwoven fabric A, and the bag was sealed by heat-welding with a part of its opening remaining. The electrolyte was poured through the remaining opening and a vacuum was established in the aluminum-laminated bag, and then the remaining opening was sealed by heat-welding, thereby forming a laminate cell.

### Example 6

A laminate cell was prepared in the same manner as in Example 5 except that lithium manganese oxide (LiMn₂O₄) having a median diameter of 10.0 μm measured by a laser diffraction method was used as the cathode active material.

### Example 7

A laminate cell was prepared in the same manner as in Example 5 except that lithium manganese oxide (LiMn₂O₄) having a median diameter of 25.0 μm measured by a laser diffraction method was used as the cathode active material.

### Example 8

A laminate cell was prepared in the same manner as in Example 5 except that the coated amount of the cathode mixture was changed to 6.00 mg/cm², the density of the cathode mixture was changed to 2.4 g/ml, and the volume porosity of the cathode mixture was changed to 32% by volume.

### Example 9

A laminate cell was prepared in the same manner as in Example 5 except that the coated amount of the cathode mixture was changed to 6.50 mg/cm², the density of the cathode mixture was changed to 2.6 g/ml, and the volume porosity of the cathode mixture was changed to 26% by volume.

### Example 10

A laminate cell was prepared in the same manner as in Example 5 except that the coated amount of the cathode mixture was changed to 8.14 mg/cm² and the coated thickness of the cathode mixture was changed to 37 μm.

### Example 11

A laminate cell was prepared in the same manner as in Example 5 except that the coated amount of the cathode mixture was changed to 9.90 mg/cm² and the coated thickness of the cathode mixture was changed to 45 μm.

### Example 12

A cathode mixture was prepared by adding 10% by mass of acetylene black (trade name: HS-100, Denka Company Limited) as an electroconductive agent and 5% by mass of polyvinylidene fluoride as a binder to 85% by mass of iron lithium phosphate (LiFePO₄) having a median diameter of 0.6 μm measured by a laser diffraction method as a cathode active material, followed by mixing them. The cathode mixture was dispersed in N-methyl-2-pyrrolidone as a dispersion medium to form a slurry, which was then applied onto a 20-μm thick aluminum foil so that the coated amount after drying of the dispersion medium would be 7.65 mg/cm², followed by drying at 120° C. for 1 hour. After the drying, pressing was performed, thereby producing a laminate cell in the same manner as in Example 5 except that a cathode was produced in which the density of the cathode mixture was 1.7 g/ml, the coated thickness of the cathode mixture was 45 μm, and the volume porosity of the cathode mixture was 43% by volume.

### Example 13

A laminate cell was prepared in the same manner as in Example 12 except that the coated amount of the cathode mixture was changed to 8.55 mg/cm², the density of the cathode mixture was changed to 1.9 g/ml, and the volume porosity of the cathode mixture was changed to 36% by volume.

### Example 14

A cathode mixture was prepared by adding 10% by mass of acetylene black (trade name: HS-100, Denka Company Limited) as an electroconductive agent and 5% by mass of polyvinylidene fluoride as a binder to 85% by mass of nickel lithium manganate (LiNi_{0.5}Mn_{1.5}O₄) having a median diameter of 9.6 μm measured by a laser diffraction method as a cathode active material, followed by mixing them. The cathode mixture was dispersed in N-methyl-2-pyrrolidone as a dispersion medium to form a slurry, which was then applied onto a 20-μm thick aluminum foil so that the coated amount after drying of the dispersion medium would be 5.10 mg/cm², followed by drying at 120° C. for 1 hour. After the drying, pressing was performed, thereby producing a laminate cell in the same manner as in Example 5 except that a cathode was produced in which the density of the cathode mixture was 1.9 g/ml, the coated thickness of the cathode mixture was 27 μm, and the volume porosity of the cathode mixture was 43% by volume.

### Example 15

As a cathode, there was used a material prepared by connecting a nickel tub by spot welding to a copper mesh cut in a rectangle shape with a size of 3.0 cm×3.5 cm with a tub welding part remaining, and then adhering metal lithium onto the mesh.

An anode mixture was prepared by adding 10% by mass of acetylene black (trade name: HS-100, Denka Company Limited) as an electroconductive agent and 5% by mass of polyvinylidene fluoride as a binder to 85% by mass of lithium titanate (Li₄Ti₅O₁₂) having a median diameter of 7.0 μm measured by a laser diffraction method as an anode active material, followed by mixing them. The anode mixture was dispersed in N-methyl-2-pyrrolidone as a dispersion medium to form a slurry, which was then applied onto a 20-μm thick aluminum foil so that the coated amount after drying of the dispersion medium would be 4.80 mg/cm², followed by drying at 120° C. for 1 hour. After the drying, pressing was performed, thereby producing an anode in which the density of the anode mixture was 1.6 g/ml, the coated thickness of the anode mixture was 33 μm, and the volume porosity of the anode mixture was 44% by volume.

The anode was cut into a rectangle having a size of 2.5 cm×3.0 cm and the anode mixture was scraped from the aluminum foil with the anode mixture in a size of 2.0 cm×2.0 cm remaining. An aluminum tub was connected by spot welding to the aluminum foil resulting from the scraping of the anode mixture.

Lithium bis(fluorosulfonyl)imide (hereinafter referred to as “LiFSI”) dried under a dry argon atmosphere was used as a solute (lithium salt), and an electrolyte was prepared by dissolving the solute in N-methyl-N-propylpyrrolidinium bis(fluorosulfonyl)imide (Py13FSI) as an ionic liquid in a proportion of 1 mol/L.

The cathode and the anode were inserted into an aluminum-laminated bag via glass fiber nonwoven fabric A, and the bag was sealed by heat-welding with a part of its opening remaining. The electrolyte was poured through the remaining opening and a vacuum was established in the aluminum-laminated bag, and then the remaining opening was sealed by heat-welding, thereby forming a laminate cell.

### Example 16

A laminate cell was prepared in the same manner as in Example 15 except that lithium titanate (Li₄Ti₅O₁₂) having a median diameter of 1.2 μm measured by a laser diffraction method was used as the anode active material, the coated amount of the anode mixture was changed to 2.70 mg/cm², the density of the anode mixture was changed to 1.8 g/ml, the coated thickness of the anode mixture was changed to 17 μm, and the volume porosity of the anode mixture was changed to 44% by volume.

### Comparative Example 4

A laminate cell was prepared in the same manner as in Example 5 except that the coated amount of the cathode mixture was changed to 17.60 mg/cm² and the coated thickness of the cathode mixture was changed to 85 μm.

### Comparative Example 5

A laminate cell was prepared in the same manner as in Example 5 except that the coated amount of the cathode mixture was changed to 6.50 mg/cm², the density of the cathode mixture was changed to 2.85 g/ml, the coated thickness of the cathode mixture was changed to 23 μm, and the volume porosity of the cathode mixture was changed to 19% by volume.

### Comparative Example 6

A laminate cell was prepared in the same manner as in Example 5 except that the coated amount of the cathode mixture was changed to 8.14 mg/cm², the density of the cathode mixture was changed to 1.9 g/ml, the coated thickness of the cathode mixture was changed to 43 μm, and the volume porosity of the cathode mixture was changed to 46% by volume.

### Comparative Example 7

A laminate cell was prepared in the same manner as in Example 12 except that the coated amount of the cathode mixture was changed to 14.45 mg/cm² and the coated thickness of the cathode mixture was changed to 85 μm.

### Comparative Example 8

A laminate cell was prepared in the same manner as in Example 12 except that the coated amount of the cathode mixture was changed to 7.20 mg/cm², the density of the cathode mixture was changed to 1.6 g/ml, and the volume porosity of the cathode mixture was changed to 47% by volume.

### Comparative Example 9

A laminate cell was prepared in the same manner as in Example 14 except that the coated amount of the cathode mixture was changed to 11.00 mg/cm² and the coated thickness of the cathode mixture was changed to 58 μm.

### Comparative Example 10

A laminate cell was prepared in the same manner as in Example 14 except that the density of the cathode mixture was changed to 1.6 g/ml, the coated thickness of the cathode mixture was changed to 32 μm, and the volume porosity of the cathode mixture was changed to 55% by volume.

### Comparative Example 11

A laminate cell was prepared in the same manner as in Example 16 except that the coated amount of the anode mixture was changed to 7.20 mg/cm², the density of the anode mixture was changed to 2.2 g/ml, the coated thickness of the anode mixture was changed to 33 μm, and the volume porosity of the anode mixture was changed to 18% by volume.

### Comparative Example 12

A laminate cell was prepared in the same manner as in Example 15 except that the coated amount of the anode mixture was changed to 5.00 mg/cm², the density of the anode mixture was changed to 1.5 g/ml, and the volume porosity of the anode mixture was changed to 47% by volume.

### Comparative Example 13

A laminate cell was prepared in the same manner as in Example 16 except that the coated amount of the anode mixture was changed to 11.00 mg/cm², the coated thickness of the anode mixture was changed to 61 μm, and the volume porosity of the anode mixture was changed to 43% by volume.

### Comparative Example 14

A laminate cell was prepared in the same manner as in Example 16 except that the volume porosity of the anode mixture was changed to 50% by volume.

[Evaluation and the Like]

### (Pore Distribution Measurement)

The pore distributions of the separators used in respective examples and comparative examples were each determined by measurement using a mercury porosimeter. The total pore volumes and the porosities obtained from the measurement using a mercury porosimeter are shown in Table 1. In addition, the air permeabilities obtained from measurement by a Gurley tester method are also shown in Table 1.

### (Characteristics Evaluation) Characteristics Evaluation of Examples 1 to 2 and Comparative Examples 1 to 2

The batteries (laminate cells) prepared in Examples 1 to 2 and Comparative Examples 1 to 2 were subjected to constant current charging to a charge termination voltage of 2.5 V at 25° C. at a constant current of 0.2 C, and then to constant current charging at a charge termination voltage of 2.5 V until the current value reached 0.01 C. The “C” used as the unit of current value means “current value (A)/battery capacity (Ah).” After an absence of activity for 15 minutes, constant current discharging was performed at a current value of 0.2 C and a discharge termination voltage of 1.0 V. Charging and discharging were repeated three times under the charge and discharge conditions described above.

Then, constant current charging was performed to a charge termination voltage of 2.5 V at a constant current of 0.2 C, and subsequently, constant voltage charging was performed at a charge termination voltage of 2.5 V until the current value reached 0.01 C. After an absence of activity for 15 minutes, constant current discharging was performed at a current value of 0.1 C and a discharge termination voltage of 1.0 V. The discharge capacity at this time was defined as an initial discharge capacity.

Furthermore, constant current charging was performed to a charge termination voltage of 2.5 V at a constant current of 0.2 C, and subsequently, constant voltage charging was performed at a charge termination voltage of 2.5 V until the current value reached 0.01 C. After an absence of activity for 15 minutes, constant current discharging was performed at a current value of 1 C and a discharge termination voltage of 1.0 V.

### Characteristics Evaluation of Examples 3 to 4 and Comparative Example 3

The batteries (laminate cells) prepared in Examples 3 to 4 and Comparative Example 3 were subjected to constant current charging to a charge termination voltage of 3.8 V at 25° C. at a constant current of 0.2 C, and then to constant current charging at a charge termination voltage of 3.8 V until the current value reached 0.01 C. After an absence of activity for 15 minutes, constant current discharging was performed at a current value of 0.2 C and a discharge termination voltage of 2.0 V. Charging and discharging were repeated three times under the charge and discharge conditions described above.

Then, constant current charging was performed to a charge termination voltage of 3.8 V at a constant current of 0.2 C, and subsequently, constant voltage charging was performed at a charge termination voltage of 3.8 V until the current value reached 0.01 C. After an absence of activity for 15 minutes, constant current discharging was performed at a current value of 0.1 C and a discharge termination voltage of 2.0 V. The discharge capacity at this time was defined as an initial discharge capacity.

Furthermore, constant current charging was performed to a charge termination voltage of 3.8 V at a constant current of 0.2 C, and subsequently, constant voltage charging was performed at a charge termination voltage of 3.8 V until the current value reached 0.01 C. After an absence of activity for 15 minutes, constant current discharging was performed at a current value of 1 C and a discharge termination voltage of 2.0 V.

The initial discharge capacities, the initial Coulomb efficiencies, and the 1 C/0.1 C constant current discharge capacity ratios (rate capabilities) of the batteries prepared in Examples 1 to 4 and Comparative Examples 1 to 3 are shown in Table 2.

### Characteristics Evaluation of Examples 5 to 11 and Comparative Examples 4 to 6

The batteries (laminate cells) prepared in Examples 5 to 11 and Comparative Examples 4 to 6 were subjected to constant current charging to a charge termination voltage of 4.3 V at 25° C. at a constant current of 0.2 C, and then to constant current charging at a charge termination voltage of 4.3 V until the current value reached 0.01 C. After an absence of activity for 15 minutes, constant current discharging was performed at a current value of 0.2 C and a discharge termination voltage of 3.0 V. Charging and discharging were repeated three times under the charge and discharge conditions described above.

Then, constant current charging was performed to a charge termination voltage of 4.3 V at a constant current of 0.2 C, and subsequently, constant voltage charging was performed at a charge termination voltage of 4.3 V until the current value reached 0.01 C. After an absence of activity for 15 minutes, constant current discharging was performed at a current value of 0.1 C and a discharge termination voltage of 3.0 V. The discharge capacity at this time was defined as an initial discharge capacity. The initial discharge capacity was calculated per unit mass of a cathode active material.

Furthermore, constant current charging was performed to a charge termination voltage of 4.3 V at a constant current of 0.2 C, and subsequently, constant voltage charging was performed at a charge termination voltage of 4.3 V until the current value reached 0.01 C. After an absence of activity for 15 minutes, constant current discharging was performed at a current value of 1 C and a discharge termination voltage of 3.0 V.

### Characteristics Evaluation of Examples 12 to 13 and Comparative Examples 7 to 8

The batteries (laminate cells) prepared in Examples 12 to 13 and Comparative Examples 7 to 8 were subjected to constant current charging to a charge termination voltage of 4.0 V at 25° C. at a constant current of 0.2 C, and then to constant current charging at a charge termination voltage of 4.0 V until the current value reached 0.01 C. After an absence of activity for 15 minutes, constant current discharging was performed at a current value of 0.2 C and a discharge termination voltage of 2.0 V. Charging and discharging were repeated three times under the charge and discharge conditions described above.

Then, constant current charging was performed to a charge termination voltage of 4.0 V at a constant current of 0.2 C, and subsequently, constant voltage charging was performed at a charge termination voltage of 4.0 V until the current value reached 0.01 C. After an absence of activity for 15 minutes, constant current discharging was performed at a current value of 0.1 C and a discharge termination voltage of 2.0 V. The discharge capacity at this time was defined as an initial discharge capacity. The initial discharge capacity was calculated per unit mass of a cathode active material.

Furthermore, constant current charging was performed to a charge termination voltage of 4.0 V at a constant current of 0.2 C, and subsequently, constant voltage charging was performed at a charge termination voltage of 4.0 V until the current value reached 0.01 C. After an absence of activity for 15 minutes, constant current discharging was performed at a current value of 1 C and a discharge termination voltage of 2.0 V.

### Characteristics Evaluation of Example 14 and Comparative Examples 9 to 10

The batteries (laminate cells) prepared in Example 14 and Comparative Examples 9 to 10 were subjected to constant current charging to a charge termination voltage of 4.95 V at 25° C. at a constant current of 0.2 C, and then to constant current charging at a charge termination voltage of 4.95 V until the current value reached 0.01 C. After an absence of activity for 15 minutes, constant current discharging was performed at a current value of 0.2 C and a discharge termination voltage of 3.5 V. Charging and discharging were repeated three times under the charge and discharge conditions described above.

Then, constant current charging was performed to a charge termination voltage of 4.95 V at a constant current of 0.2 C, and subsequently, constant voltage charging was performed at a charge termination voltage of 4.95 V until the current value reached 0.01 C. After an absence of activity for 15 minutes, constant current discharging was performed at a current value of 0.1 C and a discharge termination voltage of 3.5 V. The discharge capacity at this time was defined as an initial discharge capacity. The initial discharge capacity was calculated per unit mass of a cathode active material.

Furthermore, constant current charging was performed to a charge termination voltage of 4.95 V at a constant current of 0.2 C, and subsequently, constant voltage charging was performed at a charge termination voltage of 4.95 V until the current value reached 0.01 C. After an absence of activity for 15 minutes, constant current discharging was performed at a current value of 1 C and a discharge termination voltage of 3.5 V.

### Characteristics Evaluation of Examples 15 to 16 and Comparative Examples 11 to 14

The batteries (laminate cells) prepared in Examples 15 to 16 and Comparative Examples 11 to 14 were subjected to constant current charging to a charge termination voltage of 3.4 V at 25° C. at a constant current of 0.2 C, and then to constant current charging at a charge termination voltage of 3.4 V until the current value reached 0.01 C. After an absence of activity for 15 minutes, constant current discharging was performed at a current value of 0.2 C and a discharge termination voltage of 2.0 V. Charging and discharging were repeated three times under the charge and discharge conditions described above.

Then, constant current charging was performed to a charge termination voltage of 3.4 V at a constant current of 0.2 C, and subsequently, constant voltage charging was performed at a charge termination voltage of 2.0 V until the current value reached 0.01 C. After an absence of activity for 15 minutes, constant current discharging was performed at a current value of 0.1 C and a discharge termination voltage of 2.0 V. The discharge capacity at this time was defined as an initial discharge capacity. The initial discharge capacity was calculated per unit mass of an anode active material.

Furthermore, constant current charging was performed to a charge termination voltage of 3.4 V at a constant current of 0.2 C, and subsequently, constant voltage charging was performed at a charge termination voltage of 3.4 V until the current value reached 0.01 C. After an absence of activity for 15 minutes, constant current discharging was performed at a current value of 1 C and a discharge termination voltage of 2.0 V.

The initial discharge capacities, the initial Coulomb efficiencies, and the 1 C/0.1 C constant current discharge capacity ratios (rate capabilities) of the batteries prepared in Examples 1 to 16 and Comparative Examples 1 to 14 are shown below in Table 2 to Table 4.

TABLE 1

| | | Glass fiber | Glass fiber | Glass fiber | Cellulose fiber | Polyimide fiber |
|---|---|---|---|---|---|---|
| | | nonwoven | nonwoven | nonwoven fabric C | nonwoven | nonwoven |
| | | fabric A | fabric B | (Constitutional | fabric | fabric |
| | | (Constitutional | (Constitutional | Materials) | (Constitutional | (Constitutional |
| | | Materials) | Materials) | Glass fiber, | Materials) | Materials) |
| | | Glass fiber, | Glass fiber, | inorganic filler, | Pulp, | Polyimide, |
| Item | Unit | resin | resin | resin | fiber | resin |
| Total pore volume | ml/g | 6.59 | 5.02 | 4.6 | 1.89 | 1.61 |
| Porosity | % | 92.94 | 92.25 | 90 | 76.55 | 69.82 |
| Air permeability | s/100 ml | 1 | 1 | 9 | 12 | 5.3 |

TABLE 2

| | | | | | | Comparative | | |
|---|---|---|---|---|---|---|---|---|
| | | Examples | | | | Examples | | |
| Item | | 1 | 2 | 3 | 4 | 1 | 2 | 3 |
| Separator | Glass fiber nonwoven fabric A | ◯ | — | — | — | — | — | — |
| | Glass fiber nonwoven fabric B | — | ◯ | ◯ | — | — | — | — |
| | Glass fiber nonwoven fabric C | — | — | — | ◯ | — | — | — |
| | Cellulose fiber nonwoven fabric | — | — | — | — | ◯ | — | ◯ |
| | Polyimide fiber nonwoven fabric | — | — | — | — | — | ◯ | — |
| Cathode | LiMn₂O₄ | — | — | — | — | — | — | — |
| | LiFePO₄ | ◯ | ◯ | — | — | ◯ | ◯ | — |
| | LiNi_{0.5}Mn_{1.5}O₄ | — | — | ◯ | ◯ | — | — | ◯ |
| | Median diameter of cathode active material [μm] | 0.6 | 0.6 | 9.6 | 9.6 | 0.6 | 0.6 | 9.6 |
| | Coated amount of cathode mixture [mg/cm²] | 4.25 | 4.25 | 5.10 | 5.10 | 4.25 | 4.25 | 5.10 |
| | Density of cathode mixture [g/ml] | 1.7 | 1.7 | 1.9 | 1.9 | 1.7 | 1.7 | 1.9 |
| | Coated thickness of cathode mixture [μm] | 25 | 25 | 27 | 27 | 25 | 25 | 27 |
| | Volume porosity of cathode mixture [% by volume] | 43 | 43 | 43 | 43 | 43 | 43 | 43 |
| Anode | Li₄Ti₅O₁₂ | ◯ | ◯ | ◯ | ◯ | ◯ | ◯ | ◯ |
| | Median diameter of anode active material [μm] | 7.0 | 7.0 | 1.2 | 1.2 | 7.0 | 7.0 | 1.2 |
| | Coated amount of anode mixture [mg/cm²] | 4.95 | 4.95 | 2.70 | 2.70 | 4.95 | 4.95 | 2.70 |
| | Density of anode mixture [g/ml] | 1.6 | 1.6 | 1.8 | 1.8 | 1.6 | 1.6 | 1.8 |
| | Coated thickness of anode mixture [μm] | 33 | 33 | 17 | 17 | 33 | 33 | 17 |
| | Volume porosity of anode mixture [% by volume] | 44 | 44 | 44 | 44 | 44 | 44 | 44 |
| Characteristics | Rate capacity [%] | 85 | 83.5 | 90 | 81 | 27.1 | 50.9 | 40 |
| | Initial Coulomb efficiency [%] | 98.7 | 98.5 | 86.5 | 85.5 | 95.3 | 99.1 | 84.8 |
| | Initial discharge capacity [mAh] | 2.7 | 2.7 | 1.5 | 1.4 | 2.6 | 2.7 | 1.4 |

TABLE 3

| | | Examples | | | | | |
|---|---|---|---|---|---|---|---|
| Item | | 5 | 6 | 7 | 8 | 9 | 10 |
| Separator | Glass fiber nonwoven fabric A | ◯ | ◯ | ◯ | ◯ | ◯ | ◯ |
| | Glass fiber nonwoven fabric B | — | — | — | — | — | — |
| | Glass fiber nonwoven fabric C | — | — | — | — | — | — |
| | Cellulose fiber nonwoven fabric | — | — | — | — | — | — |
| | Polyimide fiber nonwoven fabric | — | — | — | — | — | — |
| Cathode | LiMn₂O₄ | ◯ | ◯ | ◯ | ◯ | ◯ | ◯ |
| | LiFePO₄ | — | — | — | — | — | — |
| | LiNi_{0.5}Mn_{1.5}O₄ | — | — | — | — | — | — |
| | Median diameter of cathode active material [μm] | 5.0 | 10.0 | 25.0 | 5.0 | 5.0 | 5.0 |
| | Coated amount of cathode mixture [mg/cm²] | 5.50 | 5.50 | 5.50 | 6.00 | 6.50 | 8.14 |
| | Density of cathode mixture [g/ml] | 2.2 | 2.2 | 2.2 | 2.4 | 2.6 | 2.2 |
| | Coated thickness of cathode mixture [μm] | 25 | 25 | 25 | 25 | 25 | 37 |
| | Volume porosity of cathode mixture [% by volume] | 38 | 38 | 38 | 32 | 26 | 38 |
| Anode | Li₄Ti₅O₁₂ | — | — | — | — | — | — |
| | Median diameter of anode active material [μm] | — | — | — | — | — | — |
| | Coated amount of anode mixture [mg/cm²] | — | — | — | — | — | — |
| | Density of anode mixture [g/ml] | — | — | — | — | — | — |
| | Coated thickness of anode mixture [μm] | — | — | — | — | — | — |
| | Volume porosity of anode mixture [% by volume] | — | — | — | — | — | — |
| Characteristics | Rate capacity [%] | 99.5 | 99.5 | 91.5 | 99.4 | 97.6 | 82.4 |
| | Initial Coulomb efficiency [%] | 99.7 | 99.1 | 98.8 | 98.4 | 98.1 | 99.9 |
| | Initial discharge capacity [mAh/g] | 105 | 105 | 105 | 104 | 104 | 103 |
| | | Examples | | | | | |
| Item | | 11 | 12 | 13 | 14 | 15 | 16 |
| Separator | Glass fiber nonwoven fabric A | ◯ | ◯ | ◯ | ◯ | ◯ | ◯ |
| | Glass fiber nonwoven fabric B | — | — | — | — | — | — |
| | Glass fiber nonwoven fabric C | — | — | — | — | — | — |
| | Cellulose fiber nonwoven fabric | — | — | — | — | — | — |
| | Polyimide fiber nonwoven fabric | — | — | — | — | — | — |
| Cathode | LiMn₂O₄ | ◯ | — | — | — | — | — |
| | LiFePO₄ | — | ◯ | ◯ | — | — | — |
| | LiNi_{0.5}Mn_{1.5}O₄ | — | — | — | ◯ | — | — |
| | Median diameter of cathode active material [μm] | 5.0 | 0.6 | 0.6 | 9.6 | — | |
| | Coated amount of cathode mixture [mg/cm²] | 9.90 | 7.65 | 8.55 | 5.10 | — | — |
| | Density of cathode mixture [g/ml] | 2.2 | 1.7 | 1.9 | 1.9 | — | — |
| | Coated thickness of cathode mixture [μm] | 45 | 45 | 45 | 27 | — | — |
| | Volume porosity of cathode mixture [% by volume] | 38 | 43 | 36 | 43 | — | — |
| Anode | Li₄Ti₅O₁₂ | — | — | — | — | ◯ | ◯ |
| | Median diameter of anode active material [μm] | — | — | — | — | 7.0 | 1.2 |
| | Coated amount of anode mixture [mg/cm²] | — | — | — | — | 4.80 | 2.70 |
| | Density of anode mixture [g/ml] | — | — | — | — | 1.6 | 1.8 |
| | Coated thickness of anode mixture [μm] | — | — | — | — | 33 | 17 |
| | Volume porosity of anode mixture [% by volume] | — | — | — | — | 44 | 44 |
| Characteristics | Rate capacity [%] | 62.7 | 92.2 | 90.1 | 87 | 95.7 | 95 |
| | Initial Coulomb efficiency [%] | 99.8 | 98.5 | 97.3 | 94.6 | 99.2 | 98.4 |
| | Initial discharge capacity [mAh/g] | 102 | 150 | 149 | 160 | 158 | 155 |

TABLE 4

| | | Comparative Examples | | | | | |
|---|---|---|---|---|---|---|---|
| Item | | 4 | 5 | 6 | 7 | 8 | 9 |
| Separator | Glass fiber nonwoven fabric A | ◯ | ◯ | ◯ | ◯ | ◯ | ◯ |
| | Glass fiber nonwoven fabric B | — | — | — | — | — | — |
| | Glass fiber nonwoven fabric C | — | — | — | — | — | — |
| | Cellulose fiber nonwoven fabric | — | — | — | — | — | — |
| | Polyimide fiber nonwoven fabric | — | — | — | — | — | — |
| Cathode | LiMn₂O₄ | ◯ | ◯ | ◯ | — | — | — |
| | LiFePO₄ | — | — | — | ◯ | ◯ | — |
| | LiNi_{0.5}Mn_{1.5}O₄ | — | — | — | — | — | ◯ |
| | Median diameter of cathode active material [μm] | 5.0 | 5.0 | 5.0 | 0.6 | 0.6 | 9.6 |
| | Coated amount of cathode mixture [mg/cm²] | 17.60 | 6.50 | 8.14 | 14.45 | 7.20 | 11.00 |
| | Density of cathode mixture [g/ml] | 2.2 | 2.85 | 1.9 | 1.7 | 1.6 | 1.9 |
| | Coated thickness of cathode mixture [μm] | 85 | 23 | 43 | 85 | 45 | 58 |
| | Volume porosity of cathode mixture [% by volume] | 38 | 19 | 46 | 43 | 47 | 43 |
| Anode | Li₄Ti₅O₁₂ | — | — | — | — | — | — |
| | Median diameter of anode active material [μm] | — | — | — | — | — | — |
| | Coated amount of anode mixture [mg/cm²] | — | — | — | — | — | — |
| | Density of anode mixture [g/ml] | — | — | — | — | — | — |
| | Coated thickness of anode mixture [μm] | — | — | — | — | — | — |
| | Volume porosity of anode mixture [% by volume] | — | — | — | — | — | — |
| Characteristics | Rate capacity [%] | 21.5 | 45.7 | 60.1 | 16.6 | 70.6 | 14 |
| | Initial Coulomb efficiency [%] | 77.7 | 97.8 | 98.6 | 97 | 98.2 | 93.4 |
| | Initial discharge capacity [mAh/g] | 100 | 103 | 104 | 149 | 149 | 158 |

| | | Comparative Examples | | | | |
|---|---|---|---|---|---|---|
| Item | | 10 | 11 | 12 | 13 | 14 |
| Separator | Glass fiber nonwoven fabric A | ◯ | ◯ | ◯ | ◯ | ◯ |
| | Glass fiber nonwoven fabric B | — | — | — | — | — |
| | Glass fiber nonwoven fabric C | — | — | — | — | — |
| | Cellulose fiber nonwoven fabric | — | — | — | — | — |
| | Polyimide fiber nonwoven fabric | — | — | — | — | — |
| Cathode | LiMn₂O₄ | — | — | — | — | — |
| | LiFePO₄ | — | — | — | — | — |
| | LiNi_{0.5}Mn_{1.5}O₄ | ◯ | — | — | — | — |
| | Median diameter of cathode active material [μm] | 9.6 | — | — | — | — |
| | Coated amount of cathode mixture [mg/cm²] | 5.10 | — | — | — | — |
| | Density of cathode mixture [g/ml] | 1.6 | — | — | — | — |
| | Coated thickness of cathode mixture [μm] | 32 | — | — | — | — |
| | Volume porosity of cathode mixture [% by volume] | 55 | — | — | — | — |
| Anode | Li₄Ti₅O₁₂ | — | ◯ | ◯ | ◯ | ◯ |
| | Median diameter of anode active material [μm] | — | 1.2 | 7.0 | 1.2 | 1.2 |
| | Coated amount of anode mixture [mg/cm²] | — | 7.20 | 5.00 | 11.00 | 2.70 |
| | Density of anode mixture [g/ml] | — | 2.2 | 1.5 | 1.8 | 1.8 |
| | Coated thickness of anode mixture [μm] | — | 33 | 33 | 61 | 17 |
| | Volume porosity of anode mixture [% by volume] | — | 18 | 47 | 43 | 50 |
| Characteristics | Rate capacity [%] | 52 | 60.3 | 58.6 | 65 | 20 |
| | Initial Coulomb efficiency [%] | 94 | 98.7 | 98.7 | 98.2 | 98.4 |
| | Initial discharge capacity [mAh/g] | 159 | 157 | 157 | 154 | 155 |

As shown in Table 2, it is clear that the batteries of Examples 1 to 4 have rate capacities of 80% or more and are superior to the batteries of Comparative Examples 1 to 3. As shown in Table 2, it is clear that the batteries of Examples 1 to 4 have improved rate capacities due to being equipped with the separators having porosities of from 80% to 98%. In addition, it is also clear that the batteries of Examples 1 to 4 have improved rate capacities due to being equipped with the separators having total pore volumes of 2 ml/g or more. Moreover, it is also clear that the batteries of Examples 1 to 4 have improved rate capacities due to being equipped with the separators having air permeabilities of 10 s/100 ml or less.

As shown in Table 3 to Table 4, it is clear that the batteries of the examples have improved large-current characteristics due to being equipped with the separators having porosities of from 80% to 98%, as well as the use of at least one of: (1) a cathode in which the amount of the cathode mixture applied (coated) onto one side of an aluminum foil (cathode current collector) is from 1 mg/cm² to 10 mg/cm² and the volume porosity of the cathode mixture is from 20% by volume to 45% by volume; or (2) an anode in which the amount of the anode mixture applied (coated) onto one side of an aluminum foil (anode current collector) is from 1 mg/cm² to 10 mg/cm² and the volume porosity of the anode mixture is from 20% by volume to 45% by volume.

Moreover, it is also clear that the large-current characteristic is improved by using active materials having median diameters of from 0.3 μm to 30 μm for a cathode mixture and an anode mixture and adjusting the thickness (coated thickness) of the cathode mixture and the anode mixture to from 20 μm to 80 μm.

The volume porosities of the cathode mixture and the anode mixture were calculated using the following values as true specific gravity.
LiFePO₄: 3.70
LiMn₂O₄: 4.28
Li₄Ti₅O₁₂: 3.48
LiNi_{0.5}Mn_{1.5}O₄: 4.46
Acetylene black: 1.31
Polyvinylidene fluoride: 1.77

The disclosure of Japanese Patent Application No. 2013-205268 is incorporated herein by reference in its entirety.

All publications, patent applications, and technical standards mentioned in this specification are incorporated herein by reference to the same extent as if each individual publication, patent application, or technical standard was specifically and individually indicated to be incorporated by reference.

1. A lithium ion secondary battery, comprising:
a cathode;
an anode;
a separator; and
an electrolyte comprising an ionic liquid and a lithium salt,
wherein the separator has a porosity of from 80% to 98%, and
at least one of the following conditions (1) or (2) is fulfilled:
(1) the cathode comprises a first current collector and a cathode mixture applied onto at least one side of the first current collector, wherein an amount of the cathode mixture applied onto the one side of the first current collector is from 1 mg/cm² to 10 mg/cm² and a volume porosity of the cathode mixture is from 20% by volume to 45% by volume; and
(2) the anode comprises a second current collector and an anode mixture applied onto at least one side of the second current collector, wherein an amount of the anode mixture applied onto the one side of the second current collector is from 1 mg/cm² to 10 mg/cm² and a volume porosity of the cathode mixture is from 20% by volume to 45% by volume.

2. The lithium ion secondary battery according to claim 1, wherein the separator comprises a nonwoven fabric comprising at least one selected from the group consisting of polyolefin fiber, glass fiber, cellulose fiber, and polyimide fiber.

3. The lithium ion secondary battery according to claim 1, wherein an anion component of the ionic liquid comprises at least one selected from the group consisting of N(C₄F₉SO₂)₂—, CF₃SO₃—, N(SO₂F)₂—, N(SO₂CF₃)₂—, and N(SO₂CF₂CF₃)₂—.

4. The lithium ion secondary battery according to claim 1, wherein a cation component of the ionic liquid comprises at least one selected from the group consisting of a chain quaternary ammonium cation, a piperidinium cation, a pyrrolidinium cation, and an imidazolium cation.

5. The lithium ion secondary battery according to claim 1, wherein the cathode mixture or the anode mixture comprises an active material having a median diameter determined by a laser diffraction method of from 0.3 μm to 30 μm.

6. The lithium ion secondary battery according to claim 1, wherein the separator has a total pore volume of from 2 ml/g to 10 ml/g.

7. The lithium ion secondary battery according to claim 1, wherein the separator has an air permeability of from 0.1 s/100 ml to 10 s/100 ml.

8. The lithium ion secondary battery according to claim 1, wherein the cathode mixture comprises a lithium transition metal compound as a cathode active material.
